(19) United States
(12) Patent Application Publication
(10) Pub. No.: US 2025/0093634 A1
(43) Pub. Date: Mar. 20, 2025

(54) IMAGING APPARATUS

(71) Applicant: CANON KABUSHIKI KAISHA, Tokyo (JP)

(72) Inventors: HISAFUMI EBISAWA, Tokyo (JP); ICHIRO HARADA, Kanagawa (JP); YOSHIKATSU ICHIMURA, Tokyo (JP)

(21) Appl. No.: 18/884,721

(22) Filed: Sep. 13, 2024

(30) Foreign Application Priority Data
Sep. 15, 2023 (JP) 2023-149886

(51) Int. Cl. G02B 21/06; G02B 5/04

(52) U.S. Cl. CPC G02B 21/06; G02B 5/04

(57) ABSTRACT

An imaging apparatus for phase objects includes an imaging unit that images a phase object through an imaging lens, a light irradiation unit including a collimating unit that converts a light ray emitted from a light source into a substantially parallel light ray and a branching prism that branches and outputs the substantially parallel light ray such that the phase object is irradiated with the branched substantially parallel light rays in a plurality of different directions that are not parallel to an optical axis of the imaging lens, and a placement unit on which the phase object is placed in a region in which the light rays output in the plurality of different directions by the light irradiation unit first intersect each other.

### BACKGROUND OF THE DISCLOSURE

### Field of the Disclosure

The present disclosure relates to an imaging apparatus for a phase object.

### Description of the Related Art

In observing cells in cell culture, it is important to acquire not only morphologic information but also positional information of the cells. Since cells, which are transparent phase objects, are difficult to visualize with normal brightfield microscopy, a phase contrast microscope, which has solved this issue, is widely used. A phase contrast microscope visualizes cells by providing a ring slit in a transmitted illumination unit and a phase plate for an objective lens. However, there are limitations on lenses to which a phase plate is applicable, and low magnification lenses cannot be used.

On the other hand, there is a technique called oblique illumination that visualizes phase objects to be observed by irradiating the phase objects with a transmitted light ray with a slight angle from the optical axis. A technique for visualizing cells that are present widely by using a low-magnification lens, which is not achieved by a phase contrast microscope, has also been developed by this technology (disclosed in Japanese Patent Laid-Open No. 2010-216920).

In Japanese Patent Laid-Open No. 2010-216920, in oblique illumination that is illumination in one direction, deviation in shadows around cells may be caused depending on the angle and the direction of light irradiation. This deviation can prevent the shapes of cells from being identified in image processing or the like. In addition, in oblique illumination, the positions of cells drawn may vary depending on the angle and the direction of light irradiation. Because of these, it may be difficult to accurately determine the positions and the shapes of cells only by using an oblique illumination technology.

### SUMMARY OF THE DISCLOSURE

The present disclosure provides an imaging apparatus capable of accurately acquiring information, such as the positions and the shapes of phase objects, such as cells that are present widely.

An imaging apparatus according to the present disclosure is an imaging apparatus for phase objects including: an imaging unit that images a phase object through an imaging lens, a light irradiation unit including a collimating unit that converts a light ray emitted from a light source into a substantially parallel light ray and a branching prism that branches and outputs the substantially parallel light ray such that the phase object is irradiated with the branched substantially parallel light rays in a plurality of different directions that are not parallel to an optical axis of the imaging lens; and a placement unit on which the phase object is placed in a region in which the light rays output in the plurality of different directions by the light irradiation unit first intersect each other.

Further features of the present disclosure will become apparent from the following description of exemplary embodiments with reference to the attached drawings.

### BRIEF DESCRIPTION OF THE DRAWINGS

FIG. 1 is a diagram illustrating a structure of an imaging apparatus according to an embodiment of the present disclosure.

FIG. 2 is a diagram illustrating an imaging apparatus according to a first embodiment of the present disclosure.

FIGS. 3A and 3B are diagrams illustrating an example of light distribution before and after a substantially parallel light ray passes through a branching prism according to the embodiment of the present disclosure.

FIG. 4 is a diagram illustrating an imaging apparatus according to a second embodiment of the present disclosure.

FIGS. 5A and 5B are diagrams illustrating an example of the size and the position of illumination light in an imaging range of the imaging apparatus according to the second embodiment of the present disclosure.

FIGS. 6A and 6B are diagrams illustrating an example of substantially parallel light rays output from a plurality of substantially parallel light output ports according to the embodiment of the present disclosure.

FIGS. 7A and 7B are diagrams illustrating an imaging apparatus according to a third embodiment of the present disclosure.

### DESCRIPTION OF THE EMBODIMENTS

An imaging apparatus according to an embodiment of the present disclosure will be described below with reference to the drawings.

### Imaging Apparatus

An imaging apparatus 100 according to the present embodiment includes an imaging unit 007 that images a phase object 006 through an imaging lens 008.

The imaging apparatus 100 according to the present embodiment includes a light irradiation unit 030. The light irradiation unit 030 includes a collimating unit 002 that converts a light ray emitted from a light source 001 into a substantially parallel light ray and a branching prism 003 that branches and outputs the substantially parallel light ray such that the phase object 006 is irradiated with the branched substantially parallel light rays in a plurality of directions that are not parallel to an optical axis 020 of the imaging lens 008.

The imaging apparatus 100 according to the present embodiment further includes a placement unit 004 on which the phase object is placed in a region 005 in which the light rays output in the plurality of different directions by the light irradiation unit 030 first intersect each other.

Since the imaging apparatus 100 according to the present embodiment irradiates the phase object 006, such as a cell, with light rays in the plurality of different directions as described above, the deviation of shadows of the phase object are reduced as compared with when the phase object is irradiated with oblique light in only one direction. Accordingly, information, such as the position and the shape of the phase object can be accurately acquired.

In addition, since there is the placement unit 004 that can place the phase object 006 in the region 005 in which light rays output in the plurality of different directions by the light irradiation unit 030 first intersect each other, the size of the imaging apparatus 100 can be reduced.

### Subject

A subject mainly assumed for the imaging apparatus according to the present embodiment is a phase object. In the present embodiment, the phase object is a colorless and transparent object for which the intensity of light passing through the phase object does not change, but only the phase of light passing through the phase object changes. Examples of the phase object include cells, suspending solutions containing cells, and the like.

When the phase object is a cell, the subject can be a liquid containing cells provided in a transparent container. An example of the container is a laboratory dish made of commercially available glass or polystyrene, and an example of the liquid is a solution for maintaining the survival of cells during cell culture, such as a culture medium, a normal saline solution, or a solution equivalent to a normal saline solution. The surfaces of the container that face the light irradiation unit and the imaging unit need to be optically transparent to illumination light that irradiates the phase object, but the other surfaces do not need to be optically transparent.

### Placement Unit

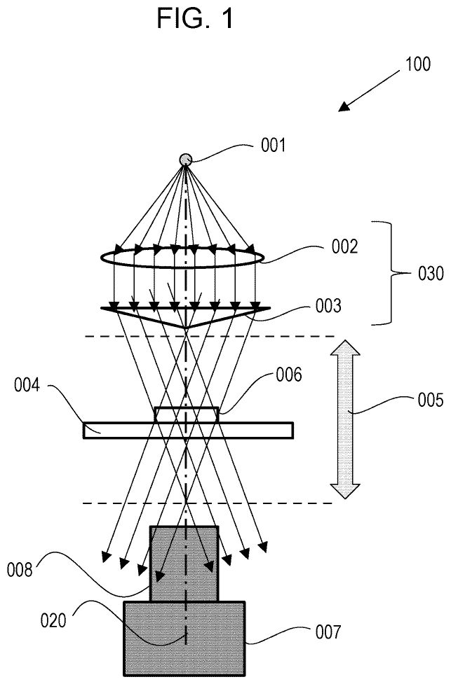

The placement unit 004 according to the present embodiment is a placement stage on which the phase object or a container having the phase object is placed, and the surfaces that face the light irradiation unit and the imaging unit need to be optically transparent to illumination light that irradiates the phase object. For example, an inverted type imaging apparatus as illustrated in FIG. 1 may have a hole formed in a portion of the placement stage closer to the imaging unit. In addition, a fixing portion for the container may be provided to prevent the container containing cells from moving due to a slight impact.

### Light Irradiation Unit

The light irradiation unit according to the present embodiment irradiates the subject with substantially parallel light rays (also referred to as collimated light rays) in a plurality of directions. The substantially parallel light rays only need to be parallel to such an extent that the effects of the present disclosure can be acquired. The light irradiation unit includes a collimating member that makes light rays from the light source parallel that is a radiation light source like a point light source and a branching prism that converts a collimated light ray into a plurality of collimated light rays.

A light ray having passed through a pinhole provided between the light source and a sample may be used, but it is also effective to use a light ray from the exit end of a bundle fiber to which a light ray from any light source has been input.

### Collimating Unit

The collimating unit according to the present embodiment converts a light ray emitted from the light source into a substantially parallel light ray (collimated light ray). A convex lens, a telecentric lenses, or the like can be used as a collimator unit (also referred to as a collimator). It should be noted that the optical axis of a collimated light ray converted by the collimating member can be concentric with the optical axis of the imaging unit.

### Branching Prism

The branching prism according to the present embodiment can be a cone prism or a polygonal pyramid prism. For example, when a square pyramid prism is used, a collimated light ray is incident on the bottom surface of the square pyramid. The incident light ray is converted into four collimated light rays bent toward the center at the equal inclination angle along the optical axis. Then, the region in which these four light rays intersect each other is irradiated with collimated light rays incident at the same inclination angle in four directions. The region irradiated with the light rays in these four directions is the capturing region.

It should be noted that, when the branching prism is a polygonal pyramid prism, as the number of sides of the polygon of the bottom surface of the prism increases, the number of branched collimated light rays increases. This means that the subject is irradiated with collimated light rays in more directions, but the area of the capturing region illuminated uniformly is reduced. When the number of sides of this polygon becomes infinite, the polygonal pyramid prism becomes a cone prism, and this cone prism is referred to as an axicon lens. When an axicon lens is used as the branching prism, the subject is irradiated with collimated light rays in all directions, but a Bessel beam is formed in the intersecting region, and the area of the capturing region uniformly illuminated becomes very narrow. Accordingly, the branching prism can be selected in accordance with the size and the characteristics of a phase object to be captured.

The light rays from the branching prism can be incident (obliquely incident) at the same angle with respect to the optical axis. To achieve this, a regular polygonal pyramid prism or an axicon lens can be used as the branching prism. In addition, the irradiation angle of a light ray can be approximately equivalent to the numerical aperture (NA) of the imaging unit. It should be noted that use of an optical sheet or the like is effective as the branching prism as long as the optical sheet exhibits the effects described above.

### Light Source

An LED light source, a halogen light source, or the like can be used as the light source in the present embodiment.

### Imaging Unit

The imaging unit according to the present embodiment acquires optical information from the subject and creates an image of the acquired optical information. The imaging unit can be a digital camera including CCDs or CMOS sensors as imaging elements. The size of imaging elements included in the imaging apparatus can be larger, and the number of pixels can be greater.

A higher number of pixels increases the resolution of the subject through digital zoom and improves the ability to draw the morphology of tiny subjects, such as cells. An example of the imaging lens included in the imaging unit according to the present embodiment is a telecentric lens, and a bilateral telecentric lens of telecentric lenses can be used.

Imaging can be performed even when the imaging lens is not a telecentric lens, but a telecentric lens can be used. This is because the unevenness of transmitted illumination can be suppressed.

In a lens with a wide angle of view, as the distance between the light irradiation unit and the lens is longer, the region of the light irradiation unit in the field of view becomes smaller, and the region of the light irradiation unit that is imaged smaller becomes a bright image. On the other hand, in a telecentric lens with a narrow angle of view, when the light irradiation unit is larger than the imaging region, a bright image can be acquired over the entire region regardless of the distance between the light irradiation unit and the lens.

Irradiation with collimated light rays in a plurality of directions has the same effect as oblique illumination in a plurality of directions at the same angle with respect to the optical axis of the imaging unit by using a plurality of collimated light sources. However, use of the branching prism is advantageous.

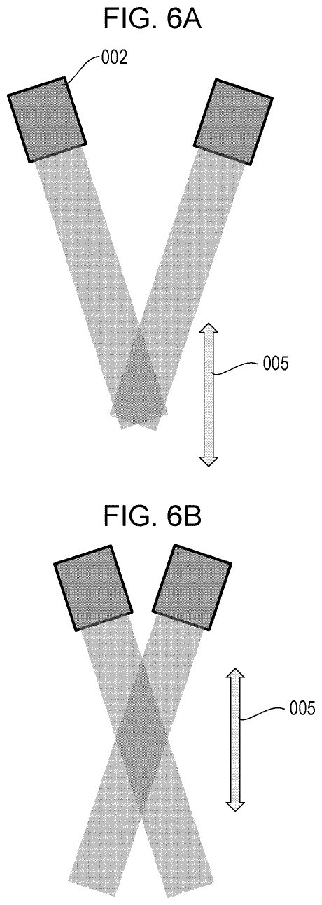

FIG. 6 illustrates irradiation with collimated light rays from a plurality of collimated light output ports. FIG. 6A illustrates a case in which the distance between collimated light emission ports is longer, and FIG. 6B illustrates a case in which the distance is shorter. The distance to the position (the region 005) in which a sample stage can be placed in FIG. 6A is longer than the distance in FIG. 6B.

In capturing in a wide range, the illumination range is also widened, and the width of the collimated light output ports need to be widened. Accordingly, the distance from the exit end to the position in which a plurality of illumination light rays completely intersect each other becomes longer.

In addition, the NA of a low-magnification lens for wide-area capturing is small, and the oblique angle of illumination light necessary for visualizing a phase object also becomes small. When the oblique angle is small, the distance from the exit end to the position in which a plurality of illumination light rays intersect each other becomes longer. In multidirectional oblique illumination in wide-area capturing, the distance from the exit end to the subject is likely to become longer, and the imaging apparatus also becomes larger. Accordingly, the distance between the plurality of collimated light output ports can be smaller.

Use of the branching prism sets the distance between the collimated light output ports to zero and can suppress the imaging apparatus from enlarging.

### Placement Unit

In the present embodiment, the placement unit on which a phase object is placed is provided in the region in which light rays output in a plurality of different directions by the light irradiation unit first intersect each other, as described above. In this structure, the size of the imaging apparatus can be reduced.

### Changing Unit

The imaging apparatus according to the present embodiment may include an intersecting region changing unit that changes the region in which the light rays intersect each other by displacing at least one of the light source, the collimating unit, and the axicon lens described above. That is, the changing unit according to the present embodiment can change the illumination position of the phase object.

The imaging apparatus described above can accurately acquire the positional information of cells, which are transparent phase objects, without having a phase plate on the lens.

### First Embodiment

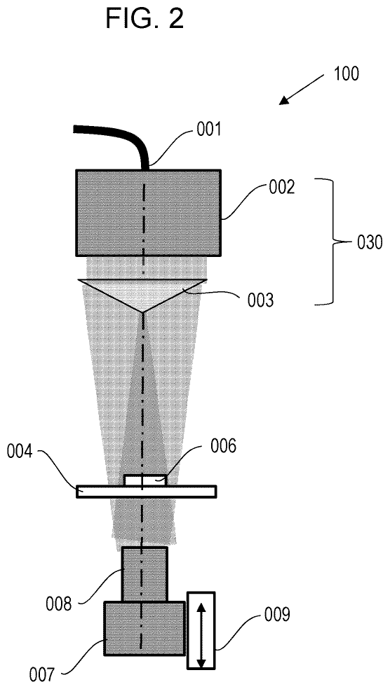

The structure of an imaging apparatus according to a first embodiment of the present disclosure will be described with reference to FIG. 2. In FIG. 2, the components that are the same as those in FIG. 1 are denoted by the same reference numerals and the descriptions thereof are omitted.

Typical observation objects of the imaging apparatus according to the present embodiment are cells. Cells that are adherently cultured in a 6-well polystyrene dish for cell culture are provided as the subject. It should be noted that the observation objects may be floating cells.

An attachment to which a universal 6-well dish can be attached is provided on the placement stage, and a plate spring that presses the dish in the horizontal direction of two axes is provided, and the dish is fixed to the placement stage by being set therein. The placement stage includes an upper member and a lower member. The upper member in contact with the dish has an opening extending over a wide range containing all six wells at the center of the dish, and only a peripheral portion of the dish is in contact with the member. The lower member has an opening that is open only in the observation area. In the upper member, the whole dish can be moved with a 2-axis stage in the horizontal direction, while the lower member is fixed in the horizontal direction. The 2-axis stage employs a manual stage having a rack and pinion structure but can employ an automatic stage that is operated by a PC or the like. A well portion to be observed is moved to the opening portion of the lower member and is moved to the observation position by the 2-axis stage.

It should be noted that, even a dish having a different shape, such as a 35 mm dish, can be fixed to the placement stage by providing a dedicated attachment.

A high-brightness LED light source with a wavelength of 565 nm, a bundled fiber, and a telecentric lens are used as the light source. The LED light source is incident on the bundle fiber, and the telecentric lens is attached to the exit end of the bundle fiber to achieve a uniform collimated light ray. The telecentric lens is placed so as to output a light ray in the vertical direction above the placement stage. The telecentric lens is adopted to output a circular uniform light ray having a diameter of approximately 50 mm as an outgoing light ray.

An acrylic square pyramid having a square bottom surface with a side length of approximately 50 mm is used as the branching prism. The angles of the four surfaces of the square pyramid are approximately 10 degrees and can polarize a collimated light ray incident perpendicularly by 5 degrees toward the optical axis. It should be noted that any material for transparent resin prisms or glass prisms of can be used.

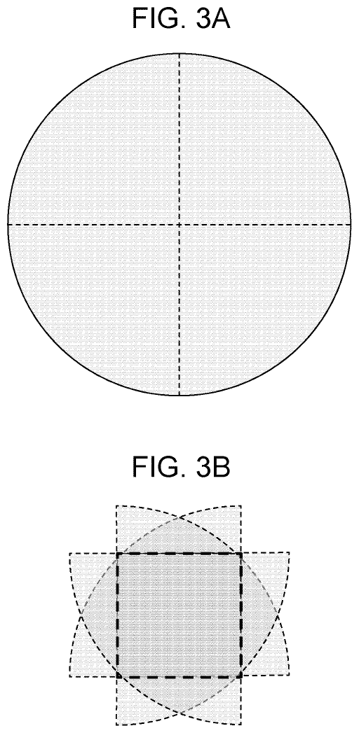

The placement stage is located approximately 140 mm from the branching prism. FIG. 3A illustrates the distribution of illumination light before incidence on the branching prism and FIG. 3B illustrates the distribution of illumination light near the placement stage. The dashed lines in FIG. 3A indicate the positions of the four sides of the branching prism. In the illumination light after passing through the branching prism, four fan-shaped sections divided by the dashed lines in FIG. 3A move toward the optical axis at the center while being inclined at an angle of 5 degrees. As a result, an illumination pattern as illustrated in FIG. 3B is formed near the placement stage.

The area at this time in which the illumination light in four directions intersects each other is a square with a side length of approximately 18 mm.

A commercially available mirrorless single-lens camera including a full-size (36 mm×24 mm) 8K pixel color CMOS sensor is adopted as the imaging unit. A commercially available 2× telecentric lens that can be placed in the imaging unit is adopted as the imaging telecentric lens. It should be noted that, when the mount of the digital camera differs from that of the imaging telecentric lens, a conversion adapter only needs to be used. The imaging telecentric lens faces the vertical upper side to be able to image the position of the opening of the lower member of the placement stage. The imaging area at this time has a size of 18 mm×12 mm and falls within the area (18 mm×18 mm) in which illumination light in four directions intersects each other, and the entire imaging region falls within the range of the same multi-directional illumination.

The imaging unit and the imaging telecentric lens have a one-axis stage 009 that moves vertically and is used for focus adjustment. In addition, a monitor that displays, in real time, an image acquired by the digital camera of the imaging unit is provided.

The imaging apparatus described above can be used to provide a system that accurately acquires the positional information of cells, which are transparent phase objects that are present widely in the dish.

### Second Embodiment

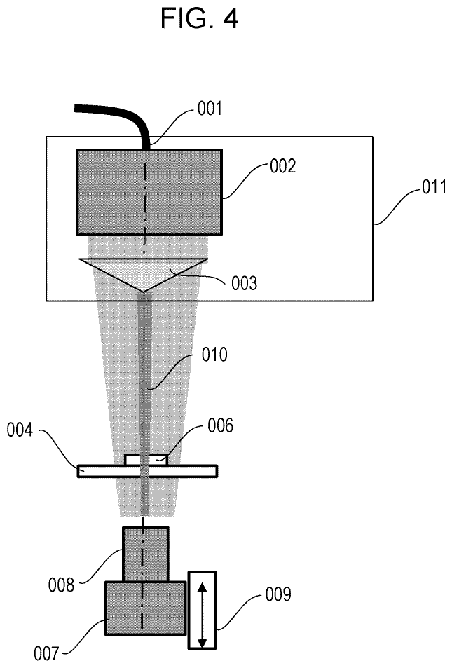

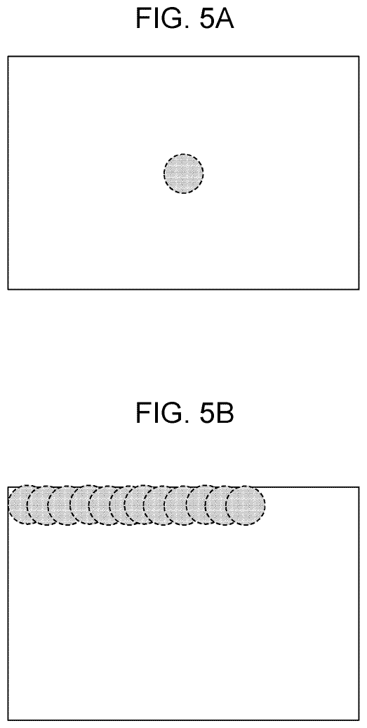

The structure of an image acquisition device according to a second embodiment of the present disclosure will be described with reference to FIGS. 4 and 5. In FIG. 4, the components the same as those in FIG. 1 are denoted by the same reference numerals and the descriptions thereof are omitted.

The device structure is substantially the same as that of the imaging apparatus according to the first embodiment illustrated in FIG. 2 except that an axicon lens is used as the branching prism, and an illumination light scanning mechanism for scanning the illumination position in the horizontal direction is attached to the illumination unit. Only the differences from the imaging apparatus according to the first embodiment will be described below.

A glass axicon lens with a diameter of approximately 50 mm is used as the branching prism. The angle is 10 degrees, and the incident collimated light ray is inclined approximately 5 degrees toward the optical axis in the specification. FIG. 5A illustrates the size and the position of illumination light in the imaging range. A Bessel beam region 010 is formed in a region in which light rays from both sides of the axicon lens intersect each other. This Bessel beam causes only a portion of the central portion of the screen to be irradiated with many collimated light rays in many directions. In addition, a cell image is displayed only in this portion.

Reference numeral 011 indicates the illumination light scanning mechanism for moving the illumination position. As illustrated in FIG. 5B, the subject in the imaging region is scanned uniformly with illumination light. The shutter of the camera of the imaging unit should be left open during this scanning. This processing causes the entire imaging region to be irradiated with collimated light rays in many directions, and an image of drawn cells can be acquired. It should be noted that the scan function can also be driven by moving the collimating member and the axicon lens horizontally and vertically while these are kept horizontally without being inclined. In addition, it is also effective to acquire a cellular image in the entire imaging region by providing an image processing unit, acquiring an image each time illumination light moves, and combining all images.

The imaging apparatus according to the present embodiment described above can be used to accurately acquire the positional information of cells, which are transparent phase objects that are present widely in the dish.

### Third Embodiment

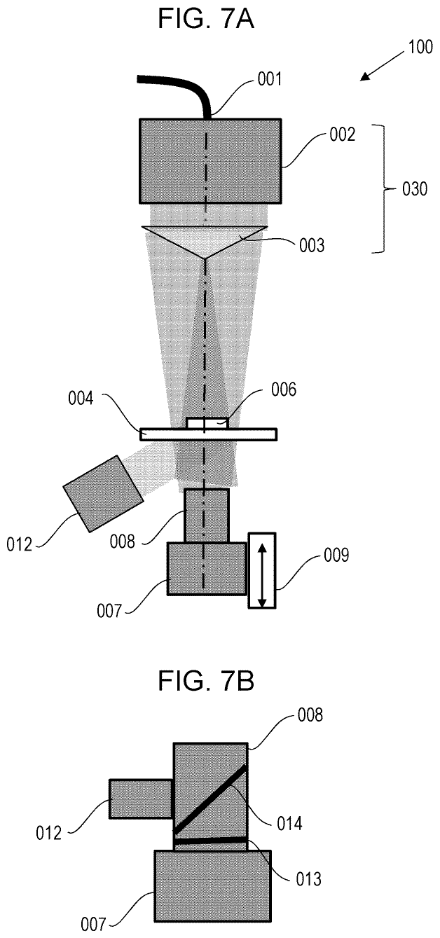

The structure of an imaging apparatus according to a third embodiment of the present disclosure will be described with reference to FIGS. 7A and 7B. In these drawings, the same components are denoted by the same reference numerals and the descriptions thereof are omitted.

The structure of the imaging apparatus according to the present embodiment can be described with reference to FIG. 7. The structure of the imaging apparatus is substantially the same as the structure of the imaging apparatus according to the first embodiment illustrated in FIG. 2 except that a fluorescent illumination unit 012 for acquiring a fluorescent image of the subject has been attached. Only the differences will be described below.

The fluorescent illumination unit irradiates the subject with a light ray at a different angle from the light irradiation unit and can acquire the fluorescence characteristics of the subject by irradiation with an excitation light ray. When the fluorescence characteristics of the subject are acquired, fluorescence information is acquired by irradiation with an incident-excitation light ray to improve the SN of an image. For example, the subject can be irradiated with an oblique excitation light ray from the imaging unit side, as illustrated in FIG. 7. In addition, when the irradiated light ray is a uniform substantially collimated light ray, the amount of light on the irradiation surface irradiated obliquely becomes uniform and is effective for homogenizing an image and relative evaluation in the screen. As in the light irradiation unit described above, such a uniform substantially collimated light ray enters a pinhole or a bundle fiber from the light source and can be achieved by installing a collimator, such as a convex lens or a telecentric lens. By using an imaging apparatus that performs diagonal irradiation, the lens can be a commercially available telecentric lens. It should be noted that a filter (for fluorescence) that removes an excitation light ray and passes only fluorescence can be placed between the subject and the imaging unit.

The wavelength of an excitation light ray is selected so as to be suited to the excitation characteristics, such as fluorescence labeling, and the type of the light source is not limited as long as the light sources has this wavelength. In addition, a combination of a wide-range xenon lamp and an excitation filter can also be used. The filter (for fluorescence) also needs be selected in accordance with the balance between the wavelength of fluorescence from the subject and the wavelength of an excitation light ray. The excitation light ray and the filter (for fluorescence) can be easily exchanged.

It should be noted that, when the subject is, for example, a cell contained in a container, oblique incident light can cause stray light by irradiating the wall of the container. To reduce this stray light, a light ray from a second light irradiation unit can be incident on a side surface of the telecentric lens as illustrated in FIG. 7B, and coaxial incident illumination can be achieved through a dichroic mirror 014 disposed in the telecentric lens. This dichroic mirror desirably has a wavelength characteristic that reflects an excitation light ray and passes the transmitted illumination light ray and fluorescence generated by the subject. In addition, a filter (for fluorescence) 013 can be provided.

The imaging apparatus described above can be used to accurately acquire positional information of cells, which are transparent phase objects that are present widely in the dish, and acquire the fluorescent staining results of the cells.

It is possible to provide an imaging apparatus that can accurately acquire information including the positions and the shapes of phase objects, such as cells that are present widely.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-149886, filed Sep. 15, 2023, which is hereby incorporated by reference herein in its entirety.

What is claimed is:

1. An imaging apparatus for phase objects, comprising:
an imaging unit that images a phase object through an imaging lens;
a light irradiation unit including a collimating unit that converts a light ray emitted from a light source into a substantially parallel light ray and a branching prism that branches and outputs the substantially parallel light ray such that the phase object is irradiated with the branched substantially parallel light rays in a plurality of different directions that are not parallel to an optical axis of the imaging lens; and
a placement unit on which the phase object is placed in a region in which the light rays output in the plurality of different directions by the light irradiation unit first intersect each other.

2. The imaging apparatus according to claim 1,
wherein the branching prism is a polygonal pyramid prism.

3. The imaging apparatus according to claim 1,
wherein the branching prism is an axicon lens.

4. The imaging apparatus according to claim 3, further comprising:
an intersection region changing unit that changes the region in which the light rays intersect each other by displacing at least one of the light source, the collimating unit, and the axicon lens.

5. The imaging apparatus according to claim 1,
wherein the phase object includes a cell.

6. The imaging apparatus according to claim 1,
wherein the collimating unit includes a convex lens or a telecentric lens.
